(19) United States
(12) Patent Application Publication
(10) Pub. No.: US 2005/0215302 A1
(43) Pub. Date: Sep. 29, 2005

(54) System and method for conducting a game of Bourre

(76) Inventor: Kenneth Badon, Lake Charles, LA (US)

Correspondence Address: Morishita Law Firm, L.L.C., Suite 850, 3800 Howard Hughes Pkwy., Las Vegas, NV, 89109, US

(21) Appl. No.: 11/090,938

(22) Filed: Mar. 25, 2005

Related U.S. Application Data
(60) Provisional application No. 60/556,757, filed on Mar. 26, 2004.

(51) Int. Cl. G06F 17/00

(52) U.S. Cl. 463/16

(57) ABSTRACT

Each player-entity, which may be processor-controlled or player controlled, antes into a player pot. Each player-entity is dealt an initial hand. A trump suit is designated. Optionally, each player-entity may have the option to fold or to play and, if playing, may have the option to discard and replace from zero or more cards. A leader plays a card to set the suit for the trick. Player-entities serially play cards. Tricks are awarded to player-entities playing the highest trump card, or the highest card in the suit for the trick. A Bourré penalty may be assessed to any player-entity winning zero tricks. The player pot is awarded to the player-entity winning the most tricks. Ties among player-entities for the greatest quantity of tricks may be resolved as a push, in favor of processor-controlled player-entities or player-controlled player-entities, or by carrying the player pot to a subsequent hand.

### RELATED APPLICATION DATA

The present application claims the priority of U.S. Provisional Application Ser. No. 60/556,757, entitled “Electronic System for the Play of Bourré,” filed Mar. 26, 2004 by Applicant herein.

### FIELD OF THE INVENTION

The present invention relates to card games. Specifically, the present invention is a system and a method for the play of Bourré, optionally in a networked environment.

### BACKGROUND OF THE INVENTION

Bourré (sometimes spelled Boure' or Boo-Ray) is a very popular card game in Southeastern United States, and particularly Louisiana. It is played between at least two players using a standard deck of playing cards. The game is played, generally, according to the rules set forth below. There may be certain regional variations. The game is well known and has been described in detail in several publications including “BOURE'”, 1972 by Roy Nickens et al, Boure' Publishing Company, Baton Rouge, La. and “Official Rules and Techniques of the Cajun Card Game Bourré, 1988, by Preston Guidry, National Bourré Association, Baton Rouge, La., the disclosures of which are hereby incorporated by reference.

Each player makes an ante wager, the amount of which is set by agreement of the players. The deck of cards is shuffled and a player designated as the dealer deals five cards to each player. The dealer turns over his fifth card the suit of which designates the trump suit for the hand of play. Each player examines his five cards and, except for certain local variations based upon the trump suit and whether the player is the dealer, has the option of playing or passing. If the player opts to pass, they throw in their cards and they are out of the hand. If the player elects to play, they may discard and replace none, some or all of his cards. Discarded cards are removed from play and replacements are dealt from the remaining deck of cards. Once all players have completed the discard replacement phase of the game, play begins. The player to the left of the dealer begins play by playing a first card. Players, in turn, must play cards in their hand following to suit, if able. If a player is “void” in a led suit, he must play a trump (or a higher trump than another trump which was played by another “voided” player). For example, if Hearts are trump and Clubs are led, a player who is void of Clubs must play a trump to take the trick. The value of the cards are ranking according to Poker, that is Ace—2, in descending order. During play, players are required to play a higher card of the led suit, e.g. must try to take the trick, no “sluffing” as in Bridge. If the player misplays, that is a renege (a “Bourré”), the consequences of which are described below.

Play continues for five tricks. The object of the game is to take as many tricks (“plays”) as you can. The player with the highest number of tricks wins the ante pot. A player who took no tricks is “Bourréd”, the consequences of which are described below. Where a hand ends with two or more players having the same highest number of tricks, e.g. two players with 2 tricks and the remaining players have 1 or no tricks, the pot is carried over to succeeding hands until there is an outright winner with the single-most number of tricks.

If there is a tie among the players for the highest number of tricks, for the next hand of play those tying players do not have to ante for the next round of play.

For the next hand of play, each player must make a new ante (except players which tied in the previous hand). If any player did not take a trick in the previous hand (he “Bourréd”), that player must ante the full amount of the previous pot. By passing, as described above, a player with a poor hand, avoids being Bourréd. If a player reneged, that player must also ante the full amount of the previous pot.

A drawback to the methods of play of Bourré is that it has been limited to live play. For tournament, players must assemble at a physical location to play. There has been no means for players to play the game from remote locations. It is believed that providing a method for players to compete from remote locations would increase interest in Bourré and would permit experienced players to compete in tournaments without the travel and lodging requirements heretofore required.

Still further, it would be advantageous to provide an electronic device and system which could provide for players, either remotely or from a single location, to play Bourré electronically.

### SUMMARY OF THE INVENTION

The present invention discloses a system and method for the play of Bourré for a plurality of player-entities, one of which is designated a dealer. In one optional embodiment, at least one player-entity is player-controlled and at least one player-entity is controlled by a data processor (i.e., is processor-controlled). Alternatively, all player-entities may be player-controlled.

According to an optional embodiment of a system of the present invention, a terminal is provided for each player-controlled player entity. The terminal, including a display, an input device, and a wager handling device, communicates with a data processor. The data processor communicates with one or more data structures that store at least a register of player-controlled player-entity credits available and a register of credits in a player pot.

Each player designates an ante wager and the ante wager is deducted from the player's credit register and contributed to the player pot register. In an optional embodiment, certain players, as described in greater detail below, are exempted from placing an ante wager to play the game.

An initial hand of cards is dealt and displayed to each player. Optionally, each player is dealt five cards. A trump suit is determined, optionally by using the suit of a randomly selected card from the dealer hand. In an optional embodiment, player-entities may opt to fold or play on. Those who play on have an opportunity to discard and replace zero or more cards. A player-entity's final hand is formed from the cards not discarded plus any replacement cards dealt. A leader is designated.

A plurality of tricks are conducted. On each trick player-entities serially play a card from the player-entity's hand. Optionally, the card played is governed by the following rules: The leader may play any card from the leader's final hand. The suit of the card played by the leader determines the suit of the trick. The player-entity must play a card suit of the trick, if possible. In an optional embodiment the card must also be higher in rank than previously played cards in the suit of the trick, if possible. If the player-entity cannot play a card from the suit played by the leader, the player-entity must play a card from the trump suit, if possible. Again, in an optional embodiment, the card must also be higher in rank than previously played cards of the trump suit, if possible. If a player-entity does not have a card of the suit of the trick or the trump suit, the player may play any card from the player-entity's hand.

The trick is awarded to the player-entity playing the highest ranking card of the trump suit, if played, or the highest ranking card of the suit of the trick, by incrementing the winning player-entity's trick register. The winner of the trick may also lead the next trick.

In an optional embodiment, a designated Bourré penalty is assessed to any player who wins zero tricks. Optionally, a Bourré penalty equal to the amount in the player pot is deducted from a player-entity's credit register and contributed to the player pot for each player-entity failing to win any tricks. However, in a further optional embodiment, any player-entity assessed a Bourré penalty may be exempted from placing an ante wager in a subsequent hand.

At least a portion of the player pot is awarded to the player-entity with a greater trick register than all other player-entities. That is, at least a portion of the credits in the player pot register are contributed to a player-entity's credit register if the player-entity is designated a pot winner by virtue of winning the greatest number of tricks. Additionally, in an optional embodiment, a player designated a pot winner is exempted from placing an ante wager on a subsequent hand.

The situation where player-entities tie for the greatest trick register could be resolved in a number of different ways. In one optional embodiment, no pot winner is designated and the player pot is carried over to a subsequent hand. In another optional embodiment, each tied player-entity is designated a pot winner and awarded at least a portion of the player pot. In yet another optional embodiment, in which at least one player-controlled player-entity and at least one processor-controlled player-entity tie, the tie could be resolved in favor of the player-controlled player entity or entities or the processor-controlled player-entity or entities.

### BRIEF DESCRIPTION OF THE DRAWINGS

FIG. 1 is a block diagram of a system according to an optional embodiment of the present invention;

FIG. 2 is a front view of a display according to an optional embodiment of the present invention before play of a trick;

FIG. 3 is a flow chart of a method according to an optional embodiment of the present invention;

FIG. 4 is a block diagram of a system according to an optional embodiment of the present invention;

FIG. 5 is a block diagram of a terminal according to an optional embodiment of the present invention.

### DESCRIPTION

Reference is now made to the figures wherein like parts are referred to by like numerals throughout. The present invention is directed to a system and method for conducting an enhanced game of Bourré for multiple player-entities. The term “player-entity” is intended to embrace both player-entities controlled by live, physical players and player-entities controlled by a data processor. Thus, the present invention specifically contemplates play exclusively by multiple, live players, i.e. all player-controlled player-entities; play by a live player against a combination of other live players and “computer” players, i.e. a mixture of player-controlled player-entities and processor-controlled player-entities; or play by a single live player against multiple “computer” players; or play by a single live player against a single “computer” player. It is noted that the optional embodiments could be conducive to play over a computer network, such as the Internet, that could connect the live players to one another and to any “computer” players. It is noted that this networked embodiment could be implemented using general purpose computers, gaming machines, personal digital assistants, cellular telephones, or other electronic devices communicating with one another, or combinations thereof. It is further noted that certain embodiments, especially the latter two embodiments where a live player plays only against one or more “computer” players, may be conducive to a non-networked gaming machine or general purpose computer.

To clarify, then, for m player-entities, where m is an integer and m>1, n of the players are player-controlled player-entities, and m-n of the player-entities are processor-controlled. In an embodiment, where m=n, all the player-entities are player-controlled. This would be a “tournament” version of the game where all player-entities are controlled by live players. In an optional embodiment in which m>n, there is at least one processor-controlled player-entity playing against at least one player-controlled player-entity. In the particular embodiment in which m=2 and n=1, there is one player-controlled player-entity playing against one processor-controlled player-entity. This particular optional embodiment would be a head-to-head game between a player and the computer may be conducive to play at a gaming machine where the relative speed of play may be a consideration.

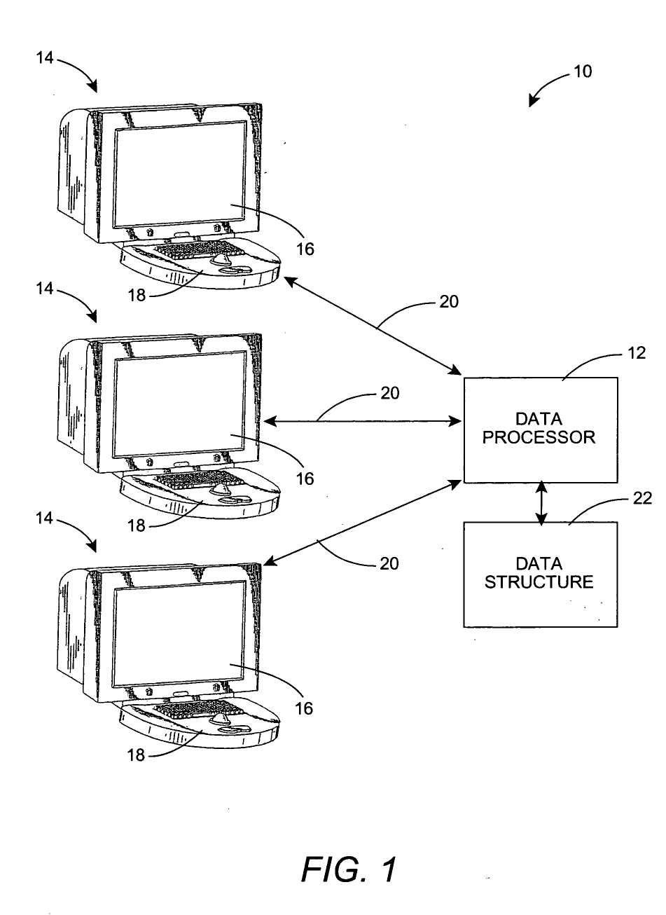

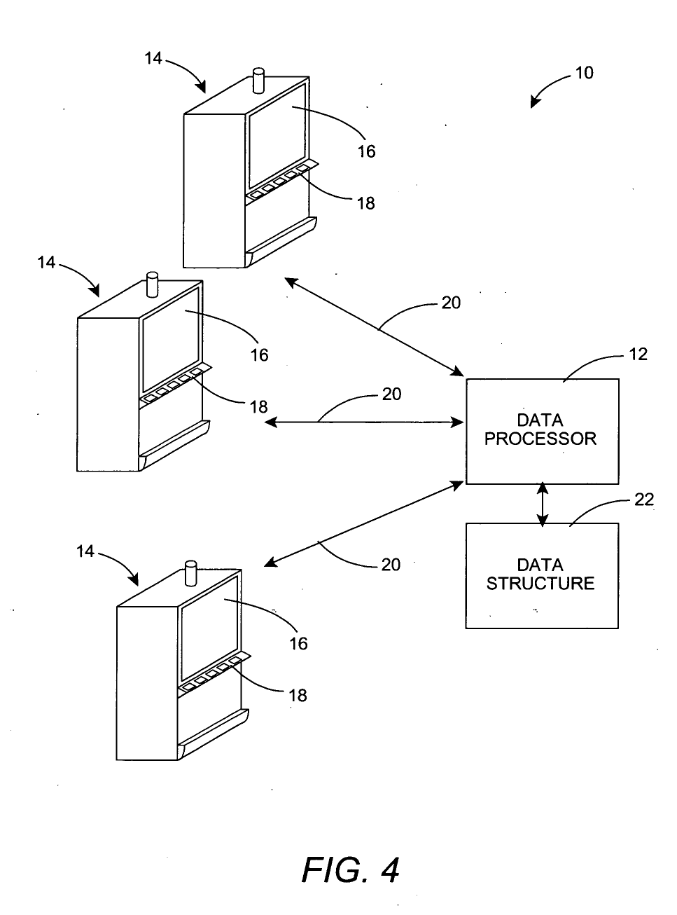

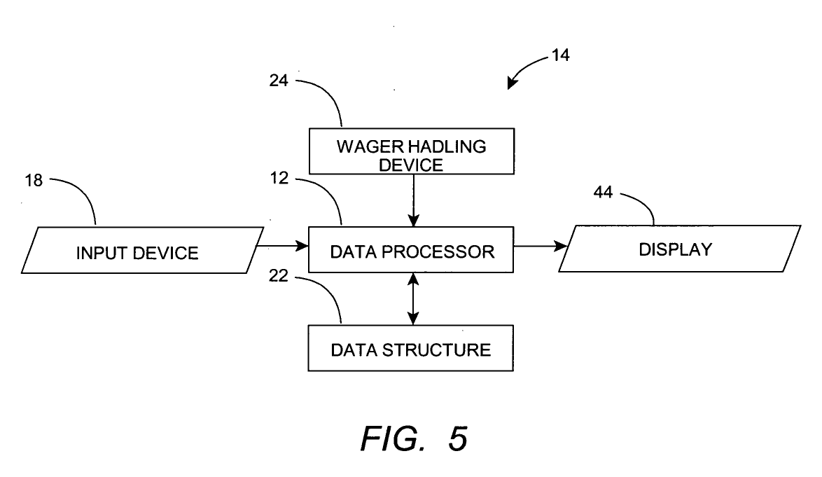

Turning to the drawings, FIGS. 1 and 4 illustrates a system 10 for the play of Bourré. The system 10 includes a data processor 12 configured as hereinafter set forth. Player terminals 14 are provided for each player-controlled player-entity to interface with a data processor 12. It is noted that the data processor 12 may be remote, such as in a networked embodiment, or local to each terminal 14, in a gaming machine embodiment, as shown in FIG. 5. Returning to FIGS. 1 and 4, while only three terminals 14 are shown, it should be understood that more or fewer terminals 14 could be provided as the number of player-entities vary. As described in greater detail below, a terminal 14 is needed to control a player-controlled player-entity. While terminals 14 could be shared, in one optional embodiment, it is contemplated that each player-controlled player-entity is associated with a separate terminal 14.

Each terminal 14 includes a display 16, such as a CRT monitor, LCD or plasma display, or other electronic display. Additionally each terminal 14 includes an input device 18 for a player to input data or instructions to control the play of his hand of Bourré, such as the sequence of play of the cards, wagering, discarding and the like. The input device 18 may be embodied as a button, keyboard, mouse, trackball, touch screen display, or any other form of device that inputs data to the data processor 12.

In an optional embodiment in which multiple terminals 14 are provided, as suggested in FIGS. 1 and 4 each terminal 14 is placed in communication with the data processor 12 through a data link 20 such as a local area network (“LAN”), wide area network (“WAN”), Internet connection or the like. In an optional embodiment in which no network is provided, as shown in FIG. 5, the terminal 14 incorporates a data processor 12 that controls the conduct of the present method.

Returning to FIGS. 1 and 4, a system 10 is configured to provide virtual, live play of the game. By virtual what is meant is that the card data is stored in a data structure 22 and the selection and distribution of the cards for the player's hands is done by the data processor 12 from the data structure 22. The data structure 22 stores data representing a register of credits available for each player-controlled player-entity, a register of credits in a player pot, and a register of tricks won by each player-entity, all of which are described in greater detail below.

Referring generally to FIGS. 1, 4, and 5, terminals 14 also incorporate a wager handling device 24. A wager handling device according to the present invention may include any means for receiving and distributing credits. As noted below, these credits need not represent an actual medium of exchange such as money, but may only serve to track the player-entity's wins and losses in the game. Games played purely for entertainment or training would typically use such game credits. However, in a gambling embodiment, the credits may actually represent a medium of exchange such as money or an account balance. Consequently, the wager handling device 24 could take many forms including a program that receives and distributes game credits, a currency acceptor, a voucher or script receiver/printer, a link to an account or line of credit, a link to a credit account, or any other means for handling the wagers and awards during the present method.

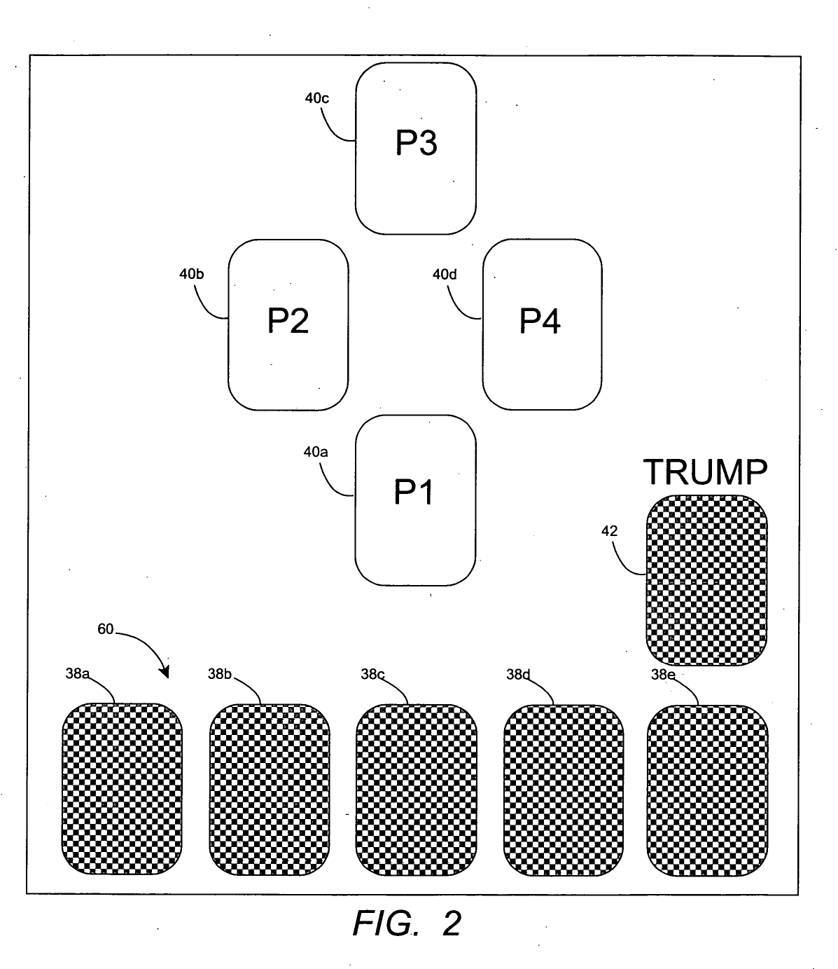

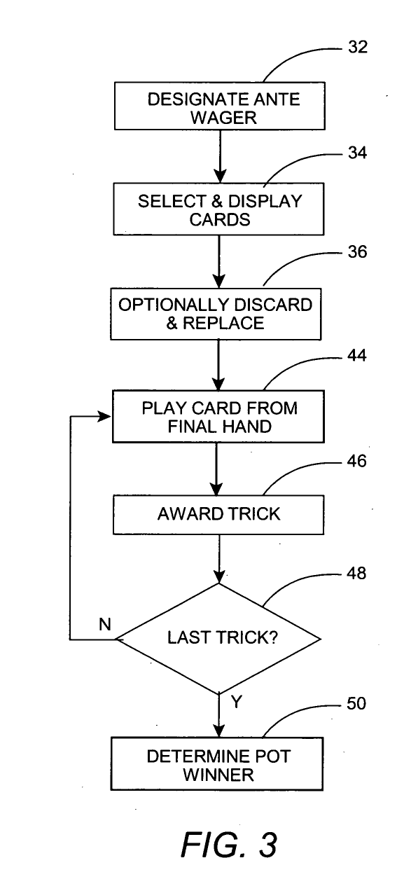

Turning to FIGS. 2 and 3 the operation and control of an embodiment of a system 10 will now be described. In one optional networked embodiment, each live player may simply use a networked terminal 14, such as one of a group of interconnected gaming machines, for play of the present game. In another optional networked embodiment, each live player wishing to participate in the play of Bourré first establishes a communication link 20 between the player's terminal 14 and the data processor 12, such by connecting a general purpose computer via a computer network, such as the Internet, for play of the present game. In such a networked embodiment, as players join the game they may be assigned into groups with other linked players, if any. Although not necessary to the present invention, digital cameras may be provided at each terminal 14 to acquire a visual image of the player which would be broadcast to all terminals 14 in the positions of the players so all players can see images of the other players.

In a non-networked embodiment of the present invention, as shown in FIG. 5, the player commences the game at his or her terminal 14. To provide credits or funds for gaming, each player uses a bank of wagering credits that is tracked at a register at the data structure 22. Where the game is played purely for entertainment or education, each player may be given fictitious game credits. Where the players are playing for money, where legal, each player would fund the play through a wager handling device 24, such as through credit card access, a pre-established account, or the like.

For each game, a “dealer” may optionally be selected from among the player-entities. The “dealer” in the present system and method would not necessarily actually “deal” cards since the data processor 12 may handle the dealing process. However, the dealer could identify the order in which cards are dealt to player-entities. That is, in an optional embodiment, when dealing initial hands and replacement cards, as discussed below, the player-entity to the dealer's immediate left is dealt to first, and the other player-entities are serially dealt their cards in clockwise order. Optionally, the draw may rotate among player-entities.

Each player controls his or her terminal 14 to designate 32 an ante wager for the player's player-entity. In an optional embodiment, however, it is contemplated that one or more player-entities may be exempted from making an ante wager, as described in greater detail below. The data processor 12 receives the input and adjusts the registers by deducting the ante wager from the player-entity's register of credits available and contributing the ante wager to the player pot register. It is contemplated that any processor-controlled player-entities may designate 32 an ante wager by the data processor 12 simply contributing an ante wager to the player pot on behalf of the processor-controlled player-entity. It is noted that in one optional embodiment, a player may opt to play multiple player-entities. That is, in an optional embodiment, a live player may control multiple hands by placing 32 an ante wager for multiple player-entities.

After players have made an ante wager the data processor 12 selects and displays 34 the cards for each player-entity. Optionally, each player-entity's hand cards are displayed only to that player-entity, while the cards for the other player-entity's are concealed. Optionally, this is accomplished by the data processor 12 sending signals to each terminal 14 to display that player-controlled player-entity's cards at the display 16.

A trump suit is also designated. Optionally, the trump card is selected randomly or quasi-randomly, such as by selecting a card from the hand of a player-entity designated the dealer. Optionally, the suit of that card is designated the trump suit for that hand, the significance of which is described in greater detail below. In an optional embodiment, player-entities may be allowed, or required, to make a supplemental wager after the trump suit is designated. Optionally, this supplemental wager occurs before any fold-or-play decision is made (as described below) and before any cards are discarded (also as described below). Optionally, the supplemental wager is contributed to the player pot.

In an optional embodiment, each player-entity may have the option fold or play. According to an optional embodiment of the present system, the player may use the input device 18 to indicate the fold-or-play decision. Player-entities opting to fold are excluded from further play of the hand. Optionally, all or a portion of a folding player-entity'ante wager is retained. Conversely, if a player-entity opts to play, the player-entity proceeds with the present method. In an optional embodiment, the player-entity may have an option, or may be required, to place a supplemental wager after opting to play. Optionally, the supplemental wager is contributed to the player pot.

Optionally, player-entities electing to play may select zero or more cards of his or her hand to discard 36. The selections made by the player at his or her terminal using the input device 18 are received at the data processor 12. Replacement cards are selected and displayed for the player-entity. While any quantity of replacement cards may be selected, it is contemplated that one replacement card is dealt for each card selected for discard. Each player-entity now has a final hand comprising the cards not discarded plus any replacement cards. Again, the player-entity may have an option, or may be required, to place a supplemental wager after receiving a final hand. Optionally, the supplemental wager is contributed to the player pot.

A plurality of tricks are conducted using the final hands. Optionally, where each player-entity is dealt h cards, h tricks are conducted with each player-entity playing one card in each trick. In an optional embodiment, one player-entity is designated the leader. The leader plays 44 a card from the leader's final hand and, in turn, each player-entity plays 44 a card from the player-entity's final hand.

FIG. 2 illustrates an example of the display of one player-controlled player-entity's cards, trump suit, and the play of the hand as it may be displayed at a display 16 at a player's terminal 14, before the player has played a card for the first trick. The five cards of the player-entity's hand (designated as the hand for Player 4 or P4) are displayed at 38a-e. The card selected for play by P4 would be displayed on the screen at 40d when played. The cards played by competing player-entities, designated P1, P2, and P3, would be displayed at 40a, 40b, and 40c, respectively, for a game with four player-entities total. The trump suit 42 may be displayed as a reminder to the player.

Returning to FIGS. 2 and 3, optionally, the data processor 12 is configured to govern the cards played by player-entities. Specifically, the card played by the leader sets the suit for the trick. Optionally, a player-entity may be required to play a card matching the suit for the trick, if possible. The player-entity may further be required to play a higher ranking card matching the suit of the trick, if possible. If the player-entity does not have a card matching the suit of the trick, the player-entity may be required to play a card of the trump suit, if possible. The player-entity may further be required to play a card of the trump suit that ranks higher than any other trump suit card played, if possible. Finally, if the player does not have a card in the suit of the trick or a trump suit, the player may play any other card.

Optionally, if a player mis-plays, the data processor 12 may simply not accept the selection. Alternatively, in an optional embodiment, the data processor 12 may display an error message to the player so the player may correct the mistake. In yet another optional embodiment, the data processor 12 may assess a renege penalty for a mis-played card. A renege penalty may take any form, but in an optional embodiment requires the player to ante an amount equal to the player pot for the next subsequent hand. That is, for a player assessed a renege penalty, an amount equal to the player pot is deducted from his credits available and contributed to the player pot as that player's ante wager for the next hand.

In an optional embodiment in which multiple player-controlled player-entities play, the live players may be responsible for identifying a renege. Any player suspecting a renege would at his or her terminal 14 send a signal to the data processor 12 identifying another player's mis-play and the basis therefor. The data processor 12 may be configured to immediately place a lien on the players credits/finds for the next hand of play (if the player has a sufficient amount) to prevent the player from signing off or refusing to ante for the next hand. The data processor 12 may be configured to calculate each player's ante for the next hand and automatically debit the player's credit for each hand of play and, in the case of a renege, for the next hand of play.

Each trick is awarded 46 to one of the player-entities. While the bases on which a trick is awarded may vary, in an optional embodiment, the trick is awarded 46 to a player-entity playing the highest ranking card from the trump suit, if played, or the highest ranking card from the suit of the trick, if no cards from the trump suit are played.

As an example, in a trick where player-entities designated Player 1, Player 2, Player 3, and Player 4 play the cards 6⋄, 2⋄, 7⋄, and 10⋄ respectively, Player 4 wins the trick for having the highest ranking card in the suit of the trick. Similarly, in a trick where the suit of the trick is spades, the trump suit is hearts, and Player 1, Player 2, Player 3, and Player 4 play the cards 7 [symbol] , J [symbol] , 5 [symbol] , and 3 [symbol] , respectively, Player 3 wins the trick for having the highest ranking card in the trump suit. When a player-entity is awarded 46 a trick, the trick register for that player-entity is incremented.

With reference to FIG. 3 the data processor 12 conducts the plurality of tricks until the last trick 48 is played. At the end of the hand, the data processor 12 determines 50 the pot winner and, in most circumstances, awards at least a portion of the player pot to the pot winner. In an optional embodiment, the pot winner is the player-entity who has been awarded the greatest quantity of tricks, i.e. has the greatest trick register. Optionally, the pot winner may be exempted from placing 32 an ante wager on a subsequent hand.

In the event of a tie for the greatest quantity of tricks, the tie could be resolved in any number of ways. For example, a tie may result in no player-entity being designated a pot winner and the player pot may be carried over to a subsequent hand. In another optional embodiment, all tied player-entities may be designated pot winners and a portion of the player pot may be awarded to each tied player-entity. In yet another optional embodiment, a tie breaker may be employed, such as a secondary game or some other mechanism to select among the tied player-entities. In another optional embodiment where at least one player-controlled player-entity ties at least one processor-controlled player-entity, the tie may be resolved in favor of the player-controlled player-entity or the processor-controlled player-entity.

In an optional embodiment, a Bourré penalty may be employed. In such an embodiment, any player-entity failing to take any tricks in a game may be assessed a Bourré penalty. While the amount of the Bourré penalty may vary, in an optional embodiment, the Bourré penalty requires the player-entity to place an ante wager in a subsequent game that is equal to the player pot. That is, in such an optional embodiment, an amount equal to the player pot is deducted from the credit register for a player-entity and, in a subsequent hand, the player pot is incremented by the amount previously deducted as that player's ante wager. Optionally, the Bourré penalty serves as the ante wager for the penalized player and the player is not also required to place a separate ante wager for the subsequent hand.

In an optional embodiment, where a player-entity is processor-controlled, or is player-controlled but is slow in playing a hand, the data processor 12 may select and play a card for the player-entity according to the rules of Bourré. In yet another optional embodiment, the data processor 12 may be configured to indicate which card the player should play during a trick so the player may better learn the game and not make a Bourré mistake or a renege. In such an optional embodiment, the player may choose to ignore the next play suggestion and select a different card for play.

While certain embodiments of the present invention have been shown and described it is to be understood that the present invention is subject to many modifications and changes without departing from the spirit and scope of the claims presented herein.

1. A system for conducting an enhanced game of Bourré for a network of m player-entities, where m>1, of which there are n player-controlled player-entities, where n<m, and n-m processor-controlled player-entities, wherein one player-entity is designated as dealer, the system comprising:
a data processor;
a terminal for each player-controlled player-entity communicating with said data processor, comprising:
a display device communicating with said data processor;
an input device communicating with said data processor; and
a wager handling device communicating with said data processor;
a data structure communicating with said data processor, said data structure storing playing cards, a register of available credits for wager for each terminal, a register of total credits accumulated in a player pot, a register of winning tricks for each player-entity, and instructions executable by said data processor for executing a method comprising:
receiving input from each player-controlled player-entity through said input device indicating an ante wager, deducting said ante wager from said credit register for said player-controlled player-entity, and contributing said ante wager to said player pot;
selecting and distributing to each player-entity an initial hand of h cards;
for each player-controlled player-entity, displaying said initial hand at said display at said player-controlled player-entity's terminal;
designating a trump suit;
serially receiving from each said player-entity through said input device a selection of zero or more cards to discard, said selection received through said input device for each player-controlled player-entity, and determined by said data processor for each processor-controlled player-entity;
removing from each player-entity initial hand said cards selected for discard;
selecting and distributing replacement cards for each player-entity, the final hand for each said player-entity comprising cards not discarded plus any replacement cards; and
conducting play of said final hand, comprising:
setting to zero said registers of winning tricks for each player-entity;
designating a player-entity as leader;
conducting play of a plurality of tricks, each trick comprising:
commencing with the leader and proceeding serially, receiving input from each player-entity through said input device identifying a card played from said player-entity's final hand;
after each player-entity has played a card, awarding said trick to a player-entity playing the highest card of said trump suit, if played, or the highest card of the suit matching the leader player-entity's card, if no trumps were played, and incrementing the register of winning tricks for said player-entity awarded said trick; and
designating said player-entity awarded said trick as leader for the next trick to be played;
where a single player-entity has a greater register of winning tricks than all other player-entities, designating said player-entity as pot winner; and
where said pot winner is a player-controlled player-entity, awarding at least a portion of said pot to said pot winner by incrementing said player-controlled player-entity register of available credits by at least a portion of the credits in said player pot register.

2. The system of claim 1 wherein said instructions further comprise:
setting a Bourré penalty at least equal to the amount in said player pot register; and
after completing play of said hand, for any player-controlled player-entity awarded zero tricks, deducting an amount equal to said Bourré penalty from that player-entity's register of credits and incrementing said player pot by said Bourré penalty for a subsequent hand.

3. The system of claim 1 wherein said instructions further comprise:
after dealing hands to said player-entities, serially receiving from each said player-entity a play-or-fold decision, said decision received through said input device for each player-controlled player-entity and determined by said data processor for each processor-controlled player-entity; and
excluding from play all player-entities deciding to fold.

4. The system of claim 1 wherein said instructions further comprise exempting each player-controlled player-entity that is a pot winner from said ante wager on subsequent hand.

5. The system of claim 1 wherein said instructions further comprise, where a plurality of player-entities have tied for the greatest register of winning tricks, designating each said player-entity as a pot winner and distributing a portion of said player pot to each said pot winner.

6. The system of claim 1 wherein said instructions further comprise, where a plurality of player-entities have tied for the greatest register of winning tricks, designating no pot winner and carrying at least a portion of said player pot to a subsequent hand.

7. The system of claim 1 wherein said instructions further comprise, where at least one processor-controlled player-entity and at least one player-controlled player-entity have tied for the greatest register of winning tricks, designating said player-controlled player-entity as a pot winner.

8. The system of claim 1 wherein said instructions further comprise, where at least one processor-controlled player-entity and at least one player-controlled player-entity have tied for the greatest register of winning tricks, designating said processor-controlled player-entity as a pot winner.

9. The system of claim 1 wherein h=5.

10. The system of claim 1 wherein n<m.

11. The system of claim 10 wherein n=1, m=2.

12. A system for conducting an enhanced game of Bourré for a network of m player-entities, where m>1, of which there are n player-controlled player-entities, where n<m, and n-m processor-controlled player-entities, wherein one player-entity is designated as dealer, the system comprising:
a data processor;
a terminal for each player-controlled player-entity communicating with said data processor, comprising:
a display device communicating with said data processor;
an input device communicating with said data processor; and
a wager handling device communicating with said data processor;
a data structure communicating with said data processor, said data structure storing playing cards, a register of available credits for wager for each terminal, a register of total credits accumulated in a player pot, a register of winning tricks for each player-entity, and instructions executable by said data processor for executing a method comprising:
displaying a register of available credits for a player-controlled player-entity at said display at said player-entity's terminal;
receiving input from each player-controlled player-entities through said input device indicating desired ante wager, deducting said ante wager from said credit register for said player-controlled player-entity, and contributing said ante wager to said player pot except player-entities designated as exempt on prior hand;
generating ante wager for each processor-controlled player-entities and contributing said ante wager to said player pot;
displaying said player pot register at each display;
selecting and distributing to each player-entity an initial hand of h cards;
for each player-controlled player-entity, displaying said initial hand at said display at said player-controlled player-entity's terminal;
designating a trump suit by randomly selecting a card;
serially receiving from each said player-entity a play-or-fold decision, said decision received through said input device for each player-controlled player-entity and determined by said data processor for each processor-controlled player-entity;
excluding from play all player-entities deciding to fold;
serially receiving from each said player-entity a selection of zero or more cards to discard, said selection received through said input device for each player-controlled player-entity, and determined by said data processor for each processor-controlled player-entity;
removing from each player-entity initial hand said cards selected for discard;
selecting and distributing replacement cards for each card selected for discard, the final hand for each said player-entity comprising cards not discarded plus any replacement cards for cards discarded; and
conducting play of said final hand, comprising:
setting to zero said registers of winning tricks for each player-entity;
designating a player-entity as leader;
conducting play of h tricks, each trick comprising:
commencing with the leader and proceeding serially, receiving input from each player-entity through said input device identifying a card played from said player-entity's final hand, the card played governed by rules of play comprising:
said leader player-entity playing any card in said leader player-entity's final hand, said card suit designating the suit of said trick;
each subsequent player-entity, in sequence, playing a card of said suit of said trick, of higher rank than any other card of said suit of said current trick previously played on said trick, if possible;
if a player-entity is unable to play a higher card of said suit of said trick, playing any card of said suit of said trick, if possible;
if said player-entity is unable to play any card of said suit of said trick, playing a card of said trump suit, if possible; and
if said player-entity is unable to play any card of said suit of said trick, or any card of said trump suit, playing any card in said player-entity hand;
after each player-entity has played a card, awarding said trick to a player-entity playing the highest card of said trump suit, if played, or the highest card of said suit of said trick, if no trumps were played, and incrementing the register of winning tricks for said player-entity awarded said trick; and
designate said winning player-entity as leader for the next trick to be played;
setting a Bourré penalty at least equal to the amount in said player pot register;
after completing play of h tricks, for any player-controlled player-entity awarded zero tricks, deducting an amount equal to said Bourré penalty from that player-entity's register of credits; and
for each player-entity having won zero tricks, incrementing said player pot by said Bourré penalty for a subsequent hand;
where a single player-entity has a greater register of winning tricks than all other player-entities, designating said player-entity as pot winner and designating said pot winner as exempt from said ante wager on a subsequent hand;
where a plurality of player-entities have tied for the greatest register of winning tricks, designating no pot winner, carrying at least a portion of said player pot to a subsequent hand, and designating each said tied player-entity as exempt from said ante wager on a subsequent hand; and
where said pot winner is a player-controlled player-entity, awarding said pot by incrementing said player-controlled player-entity register of available credits by the number of credits in said player pot register; and
resetting said player pot register to zero.

13. The system of claim 12 wherein said instructions further comprise:
setting a renege penalty at least equal to the amount in said player pot register; and
during play of said hand, for any player-controlled player-entity identifying for play a card contrary to said rules of play, deducting an amount equal to said renege penalty from that player-entity's register of credits and incrementing said player pot by said renege penalty for a subsequent hand.

14. The system of claim 12 wherein h=5.

15. The system of claim 12 wherein n<m.

16. The system of claim 15 wherein n=1, m=2.

17. The system of claim 13 wherein player-entities playing a card in said trump suit must play a card higher in rank than all cards in said trump suits previously played on said trick, if possible.

18. A method for conducting an enhanced game of Bourré using electronic representations of playing cards for a plurality of player-entities, wherein at least one player-entity controlled by a player and at least one player-entity is controlled by a data processor, one of said player-entities designated as dealer, the method comprising:
providing a data structure storing playing cards, a register of available credits for wager for each player-controlled player-entity, a register of total credits accumulated in a player pot, and a register of winning tricks for each player-entity;
each player-controlled player-entity placing an ante wager, said ante wager deducted from said credit register for said player-controlled player-entity and contributed to said player pot register;
selecting and distributing to each player-entity an initial hand of h cards;
for each player-controlled player-entity, displaying said player-entity's initial hand;
designating a trump suit;
serially receiving from each said player-entity a selection of zero or more cards to discard, said selection received through said input device for each player-controlled player-entity and determined by said data processor for each processor-controlled player-entity;
removing from each player-entity initial hand said cards selected for discard;
selecting and distributing replacement cards for each player-entity, the final hand for each said player-entity comprising cards not discarded plus any replacement cards; and
conducting play of said final hand, comprising:
setting to zero said registers of winning tricks for each player-entity;
designating a player-entity as leader;
conducting play of a plurality of tricks, each trick comprising:
commencing with the leader and proceeding serially, each player-entity playing a card from said player-entity's final hand;
after each player-entity has played a card, awarding said trick to a player-entity playing the highest card of said trump suit, if played, or the highest card of the suit matching the leader player-entity's card, if no trumps were played, and incrementing the register of winning tricks for said player-entity awarded said trick; and
designating said player-entity awarded said trick as leader for the next trick to be played;
where a single player-entity has a greater register of winning tricks than all other player-entities, designating said player-entity as a pot winner; and
where said pot winner is a player-controlled player-entity, awarding at least a portion of said pot to said pot winner by incrementing said player-controlled player-entity register of available credits by at least a portion of the credits in said player pot register.

19. The method of claim 18 further comprising:
setting a Bourré penalty at least equal to the amount in said player pot register;
after completing play of said tricks, for any player-controlled player-entity awarded zero tricks, deducting an amount equal to said Bourré penalty from that player-entity's register of credits; and
for each player-entity having won zero tricks, incrementing said player pot by said Bourré penalty.

20. The method of claim 19 further comprising, exempting each player-entity paying said Bourré penalty from said ante wager on a subsequent hand.

21. The method of claim 18 further comprising:
after dealing hands to said player-entities, serially receiving from each said player-entity a play-or-fold decision, said decision received through said input device for each player-controlled player-entity and determined by said data processor for each processor-controlled player-entity; and
excluding from play all player-entities deciding to fold.

22. The method of claim 18 further comprising, exempting each player-controlled player-entity that is a pot winner from said ante wager on subsequent hand.

23. The method of claim 18 further comprising, where a plurality of player-entities have tied for the greatest register of winning tricks, designating each said player-entity as a pot winner and distributing a portion of said player pot to each said pot winner.

24. The method of claim 18 further comprising, where a plurality of player-entities have tied for the greatest register of winning tricks, designating no pot winner and carrying at least a portion of said player pot to a subsequent hand.

25. The method of claim 18 further comprising, where at least one processor-controlled player-entity and at least one player-controlled player-entity have tied for the greatest register of winning tricks, designating said player-controlled player-entity as a pot winner.

26. The method of claim 18 further comprising, where at least one processor-controlled player-entity and at least one player-controlled player-entity have tied for the greatest register of winning tricks, designating said processor-controlled player-entity as a pot winner.

27. The method of claim 18 wherein h=5.

28. The method of claim 18 wherein n<m.

29. The method of claim 28 wherein n=1, m=2.
